(19) United States
(12) Patent Application Publication
(10) Pub. No.: US 2009/0154903 A1
(43) Pub. Date: Jun. 18, 2009

(54) Memory medium, in particular a dvd disc, storing interactive movies

(76) Inventor: Riccardo Saetti, Cognento (IT)

Correspondence Address: ROBERTS MLOTKOWSKI SAFRAN & COLE, P.C.;Intellectual Property Department, P.O. Box 10064, MCLEAN, VA, 22102-8064, US

(21) Appl. No.: 11/587,125

(22) PCT Filed: Apr. 14, 2005
(86) PCT No.: PCT/IT2005/000218

§ 371 Date: Apr. 19, 2007

(30) Foreign Application Priority Data
Apr. 23, 2004 (IT) RM2004A000201

(51) Int. Cl. H04N 5/00

(52) U.S. Cl. 386/126; 386/E05.001

(57) ABSTRACT

The present invention concerns a memory medium storing a set of sub-movies and one or more graphic interfaces, readable by a video player having a display on which it is apt to play at least one sequence of two or more sub-movies conditional on one or more selections made by at least one user through at least one control device apt to interact with the video player, characterised in that at least one of said one or more selections is made at the end of playing a first sub-movie for selecting a second sub-movie from a sub-set of sub-movies corresponding to the first sub-movie, at the end of playing the first sub-movie being displayed on the display at least one interface, corresponding to the first sub-movie, of said one or more graphic interfaces.

The present invention further concerns the apparatuses and the instruments cooperating with the medium.

The present invention concerns a memory medium, in particular a DVD (“Digital Versatile Disk”) disc, storing interactive movies, that allows, in a reliable, simple, and inexpensive way, playing at least one sequence of two or more sub-movies conditional on one or more selections made by at least one user.

The present invention further concerns the apparatuses and the instruments cooperating with the medium.

It is known that training and instructive updating activities are presently essential in both academic field, obviously, and industrial field, including in the latter definition companies having personnel involved in technological development and/or personnel involved in marketing and commercialisation of company goods or services. The need for such instructive activities is being increasingly diffusing due to high dynamicity that presently characterises most of the technological fields and to the high competition among companies, that causes new commercial assistance activities to be created.

In order to maintain its competitiveness, it is therefore necessary for a company (as well as for a research institution such as a school or a university) to continuously carry out training of new personnel, such as agents, representatives, commercial and technical operators, installers (in case of a research institution, new students or researchers), and instructive updating of the existing personnel (in case of a research institution, researchers and professors).

Most of all in medium-large companies or research institutions, comprising some hundreds or even some thousands of employees, such instructive activities may not be easily carried out, due to the large number of instructors needed and the consequent instruction disuniformity, both in time and in contents.

A further drawback of training carried out by means of an instructor is that supplied courses are often not enough pleasant for students, causing a poor attention and assimilation of instructive contents, besides not satisfying, due to the unforeseeable development of a room lesson, those specific aspects, which have to be preliminarily carefully scheduled, that didactic psychology indicates as necessary for maximising the learning level.

Presently available remote training (e.g. through Internet link or through CDROM storing courses) systems may only partly solve the problem of supplying courses to a plurality of persons according to some certain psychological characteristics, but they suffer from some drawbacks.

These are mainly due to the fact that interactivity allowed to students is rather low, and typically limited to carrying out intermediate and final tests, followed by providing the correct responses to the questions asked by the test, and (possibly except for the final test) by successive section of the training course, the content of which is independent of the specific results of the tests. Possibly, successive section of the training course may be conditional on passing a minimum mark in the preceding test. In this regard, it has to be taken account that a high interactivity by students is an essential characteristic for making the learning level maximum.

Similar problems occur in the case when, a company organises, instead of a training course, meeting for promoting a new product or service for its own customers or potential customers, meetings where it would be fundamental to obtain a strong involvement of participants in order to allow a precise and complete assimilation of messages.

A similar interactivity problem presents in a different application field of enjoying video movies: the entertainment one.

In fact, thanks to the interest shown by users in some pilot cases, that has demonstrated the potential commercial success of such entertainment forms, some technical solution apt to allow audience to directly contribute to decide the course of a movie story are being developed. By way of example, some solutions are known which take advantage of the interactivity offered by the combination of television and telephony, wherein a movie course may be modified by the public, by interrupting movie playing, asking a question to the public concerning the possible continuation of the story, analysing preferences of users provided via telephone and/or Internet, and resuming movie playing on the basis of the majority of recorded preferences. Similar solutions are those asking, within a movie theatre, to the members of the audience which continuation of the story they prefer and, on the basis of responses received through communications means, also local to the theatre, playing the movie selected following part that is contained in a corresponding film.

However, such technical solutions, wherein the development of a movie is decided by the audience, suffer from the drawback of being made through extremely complex systems, which cannot be simply applied to enjoying forms more limited as to the number of users.

It is therefore an object of the present invention to allow, in a reliable, simple, and inexpensive way, playing interactive movies conditional on one or more selections made by at least one user.

It is therefore an object of the present invention to provide apparatuses and instruments allowing playing such interactive movies.

It is therefore specific subject matter of the present invention a memory medium storing a set of sub-movies and one or more graphic interfaces, readable by a video player having a display on which it is apt to play at least one sequence of two or more sub-movies conditional on one or more selections made by at least one user through at least one control device apt to interact with the video player, characterised in that at least one of said one or more selections is made at the end of playing a first sub-movie for selecting a second sub-movie from a sub-set of sub-movies corresponding to the first sub-movie, at the end of playing the first sub-movie being displayed on the display at least one interface, corresponding to the first sub-movie, of said one or more graphic interfaces.

Always according to the invention, at least one sub-movie of said set may comprise two or more video and/or audio component sequences.

Still according to the invention, at least two sub-movies of said set may comprise at least one same video and/or audio component sequence.

Furthermore according to the invention, said medium may store, for each sub-movie comprising two or more video sequences and/or audio components, references or pointers to the memory locations of the medium storing the corresponding video and/or audio component sequences.

Always according to the invention, said at least one interface corresponding to the first sub-movie may comprise at least two selectable fields.

Still according to the invention, at least one of said at least two selectable fields may be a text field.

Furthermore according to the invention, said at least one interface corresponding to the first sub-movie may show at least one question.

Always according to the invention, said at least one interface corresponding to the first sub-movie may comprise at least one panel showing an image and/or a video and/or audio sequence.

Still according to the invention, said at least one interface corresponding to the first sub-movie may comprise at least one video and/or audio sequence that is played during display of the corresponding interface.

Furthermore according to the invention, said medium may be a DVD (“Digital Versatile Disk”) disc, or a CDROM disc, or a USB memory card.

It is also specific subject matter of the present invention an electronic file comprising at least one data structure storing a set of sub-movies and one or more graphic interfaces, apt to be stored on the previously described memory medium.

It is still specific subject matter of the present invention an electric, magnetic, or electromagnetic signal modulated by an information signal, characterised in that said information signal comprises the just described electronic file.

It is further specific subject matter of the present invention a video playing system, comprising a video player, provided with at least one display, apt to read at least one memory medium as previously described, the system comprising at least two control devices apt to interact with the video player, the system being characterised in that it comprises a device for receiving peripheral selection signals coming from said at least two control devices, the receiving device transmitting a central selection signal towards the video player upon reception of a minimum number of peripheral selection signals, the central selection signal corresponding to the majority peripheral selection signal among those received by the device

Always according to the invention, said receiving device may be apt to recognise the control devices from which said peripheral selection signals come.

Still according to the invention, the receiving device may transmit a central selection signal towards the video player upon reception of a minimum number of peripheral selection signals corresponding to the same selection.

Furthermore according to the invention, the receiving device may be integrated into the video player.

Always according to the invention, said system may comprise processing means apt to calculate at least one score depending on the interactions of said at least two control devices with the video player.

It is always specific subject matter of the present invention a video playing system, comprising a video player, provided with at least one display, apt to read at least one memory medium as previously described, the system comprising at least one control device apt to interact with the video player, the system being characterised in that it comprises processing means apt to calculate at least one score depending on the interactions of said at least one control devices with the video player.

The present invention will now be described, by way of illustration and not by way of limitation, according to its preferred embodiment, by particularly referring to the Figures of the enclosed drawings, in which:

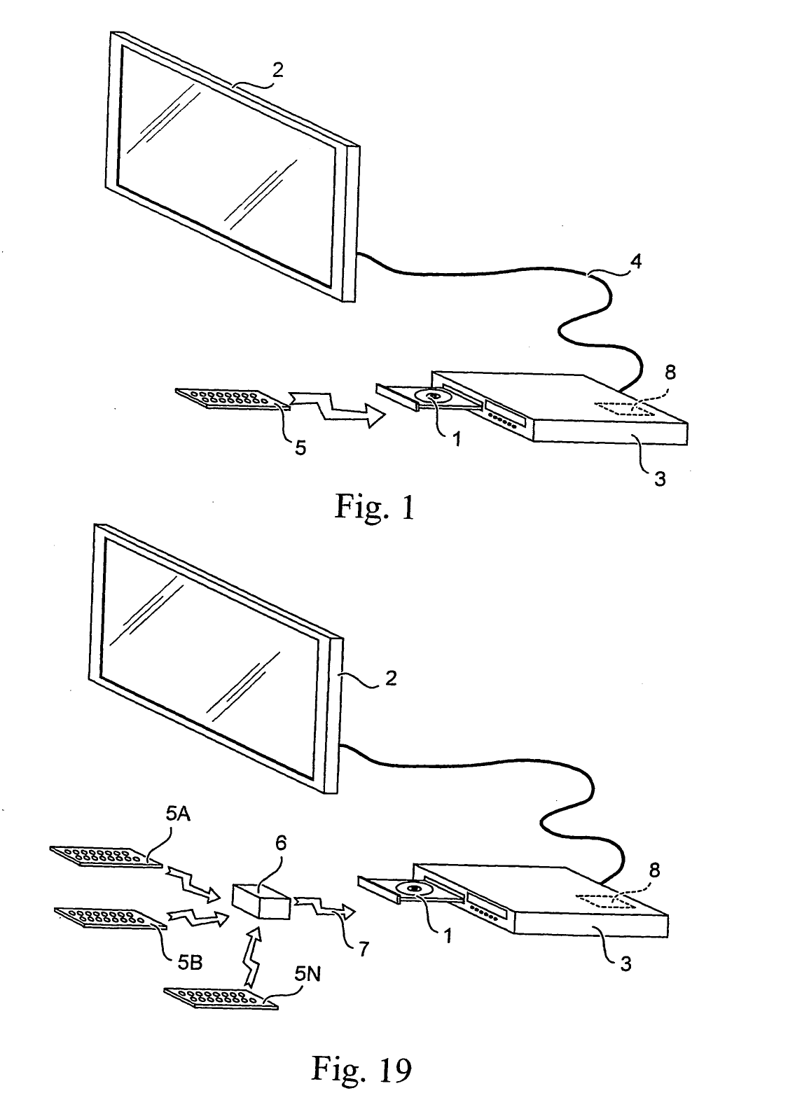

FIG. 1 schematically shows a system employing a preferred embodiment of the memory medium according to the invention;

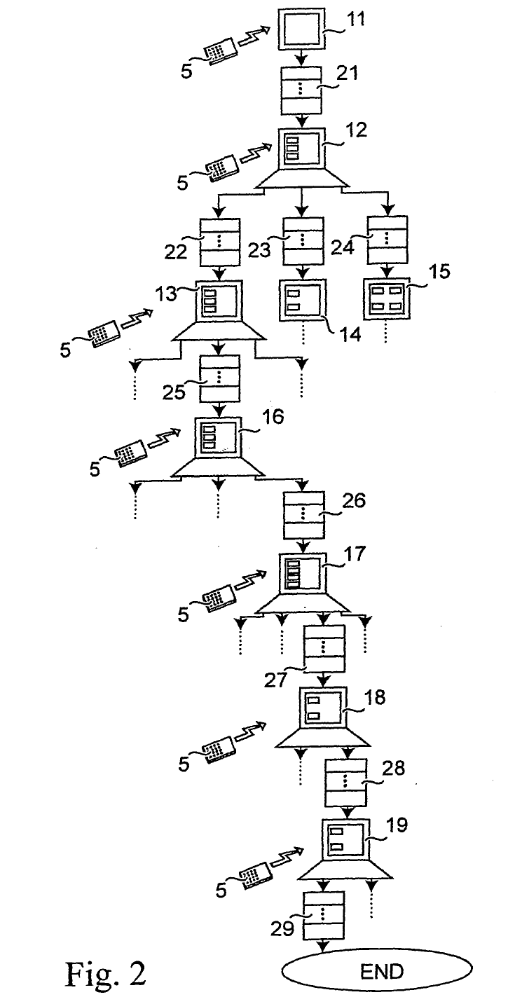

FIG. 2 schematically shows the various steps of playing an interactive movie stored on the medium of FIG. 1;

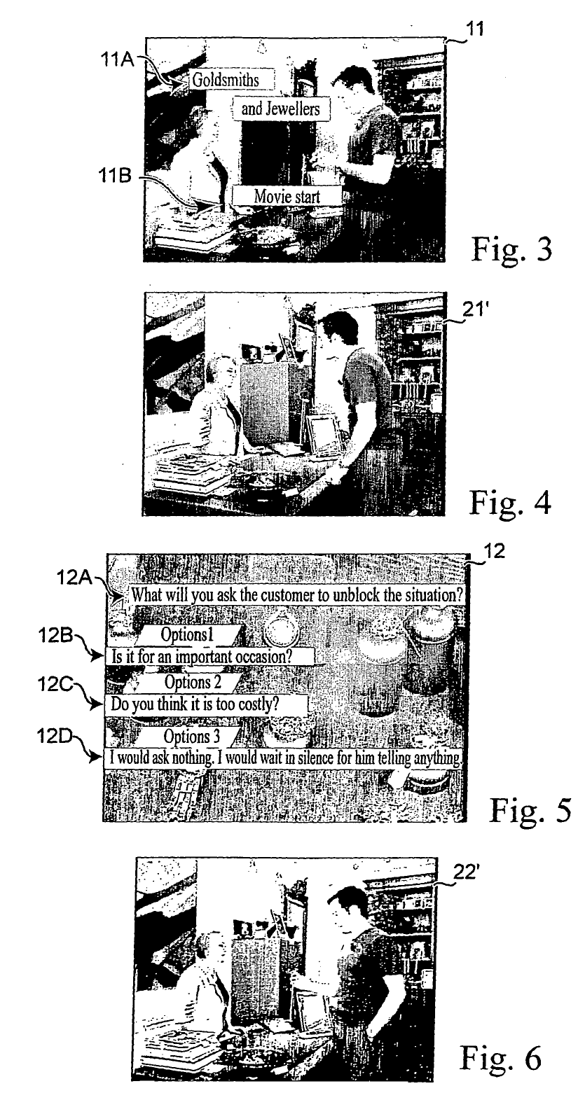

FIGS. 3-18 show some interfaces and images of the interactive movie stored on the medium of FIG. 1; and

FIG. 19 schematically shows a second embodiment of the system employing the memory medium according to the invention.

In the Figures, alike elements are indicated by the same reference numbers.

Moreover, in the following description reference will be mainly made, only by way of example and not by way of limitation, to DVD discs as memory media, but it should to be understood that that the memory medium according to the invention may be of any type, e.g. a CDROM or a USB memory card.

With reference to FIG. 1, it may be observed a system employing a preferred embodiment of the memory medium according to the invention storing an interactive movie.

Such medium is implemented as a DVD disc 1 storing, according to an inventive data structure, some graphic interfaces and some video sub-movies, interfaces and sub-movies being played on a display 2 (e.g., a television) of a DVD player 3 (connected to the television 2 through a cable 4). A user may interact with such graphic interfaces by means of a remote controlling device, i.e. a remote control 5, apt to transmit signals to the DVD player 3 which, depending on the selection made by the user on the remote control 5, plays on the display 2 a new sub-movie and/or a new graphic interface stored on the DVD disc 1.

By way of mere example and not by way of limitation, FIG. 2 shows the various steps of playing an interactive movie stored on the DVD disc of FIG. 1.

At the beginning of the interactive movie playing, the display 2 shows an initial interface 11 requiring a suitable selection by a user through the remote control 5 in order to start playing the interactive movie. By way of example, such interface 11 is shown in FIG. 3, where it may be read the movie title 11A (“Goldsmiths and Jewellers”) and a selectable text 11B (“Movie start”), that the user may select through the remote control 5 for making interactive movie playing by the DVD player 3 start. In particular, the interactive movie, of which FIGS. 3-18 show some interfaces and images, is a training movie related to sales techniques. Obviously, the DVD disc 1 could also store a training movie related to a different topic, or an interactive movie the course of the story of which could be decided by a user through the remote control 5.

Returning to FIG. 2, upon the mentioned suitable selection of the interface 11 through the remote control 5 (by selecting the text 11B of FIG. 3), the DVD player 3 plays on the display 2 a first sub-movie 21 stored on the DVD disc 1, of which FIG. 4 shows an image 21′.

At the end of first sub-movie playing, the display 2 shows a second interface 12 requiring a suitable selection through the remote control 5. By way of example, such interface 12 is shown in FIG. 5, where it may be observed a question 12A and three selectable texts 12B, 12C, and 12D, corresponding to the three possible response to question 12A which the user may select through the remote control 5.

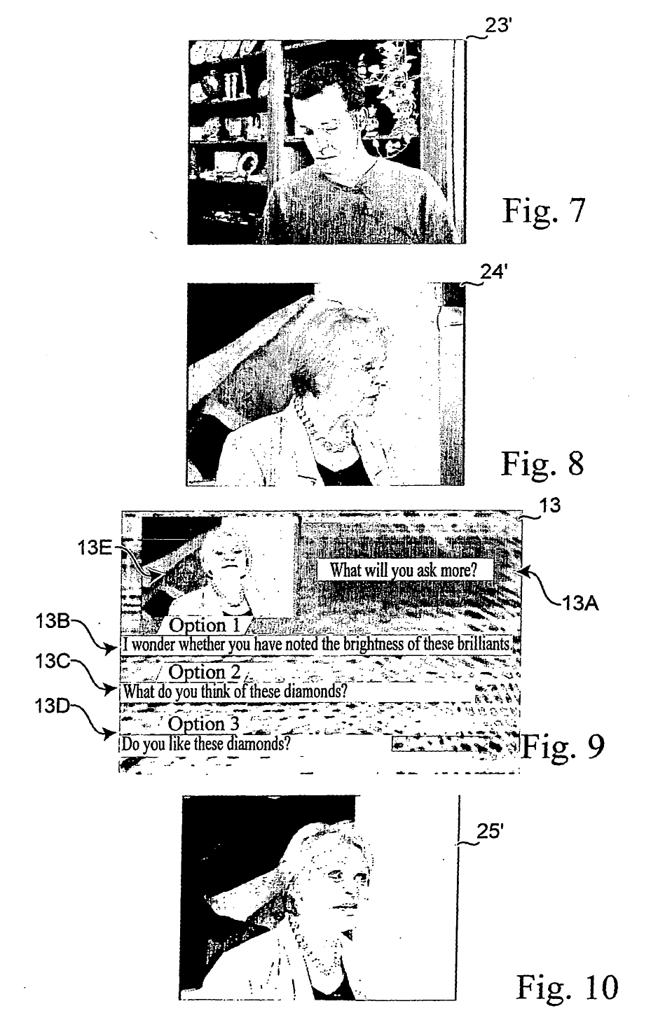

Making reference back to FIG. 2, depending on the response selected through the remote control 5, the DVD player 3 plays on the display 2 one of three sub-movies stored on the DVD disc 1:
a first sub-movie 22 (corresponding to the selection of the first selectable text 12B of FIG. 5), of which FIG. 6 shows an image 22′, at the end of playing which the display 2 shows a third interface 13 requiring a suitable selection from three possible selectable options through the remote control 5;
a second sub-movie 23 (corresponding to the selection of the second selectable text 12C of FIG. 5), of which FIG. 7 shows an image 23′, at the end of playing which the display 2 shows a fourth interface 14 requiring a suitable selection from two possible selectable options through the remote control 5; or
a third sub-movie 24 (corresponding to the selection of the third selectable text 12D of FIG. 5), of which FIG. 8 shows an image 24′, at the end of playing which the display 2 shows a fifth interface 15 requiring a suitable selection from four possible selectable options through the remote control 5.

In particular, the three sub-movies 22, 23, and 24 may be different each from the other, or they may at least partially coincide, for instance in the case when two selectable responses are followed by a same sub-movie or by two respective sub-movies which, though they differently begin, have a same final video sequence. The latter possibility may for instance occur in case of an interactive training movie, wherein the sub-movies, corresponding to each response of at least some interfaces, begin with an explanation (e.g. by just a character of the interactive movie) of why the response is either correct or wrong, and they may continue with the same video sequence showing the same story episode.

Assuming that the user has selected through the remote control 5 the first response (i.e. the first selectable text 12B of FIG. 5), as said, the DVD player 3 plays on the display 2 the first sub-movie 22, at the end of playing which the display 2 shows a third interface 13.

By way of example, such interface 13 is shown in FIG. 9, where it may be observed a question 13A and three selectable texts 13B, 13C, and 13D, corresponding to the three possible responses to the question 13A which the user may select through the remote control 5. In particular, the interface 13 further comprises a panel 13E wherein an image and/or, more preferably, a video sequence are shown in which one of the characters of the interactive movie appears (e.g. while waiting for receiving the response by the user and/or while verbally address again the question 13A). In the case when the panel 13E shows a video sequence, that may be played back until one of the selectable texts 13B, 13C, and 13D is selected, this psychologically increases the attention level of the users. Obviously, all the graphic interfaces which are shown at the end of a sub-movie for soliciting a selection by the users may be provided with similar panels showing images and/or video sequences having varying content.

Returning to FIG. 2, assuming that the user has selected through the remote control 5 the second response (i.e. the first selectable text 13C of FIG. 9), the DVD player 3 plays on the display 2 a sub-movie 25 corresponding to such response, of which FIG. 10 shows an image 25′.

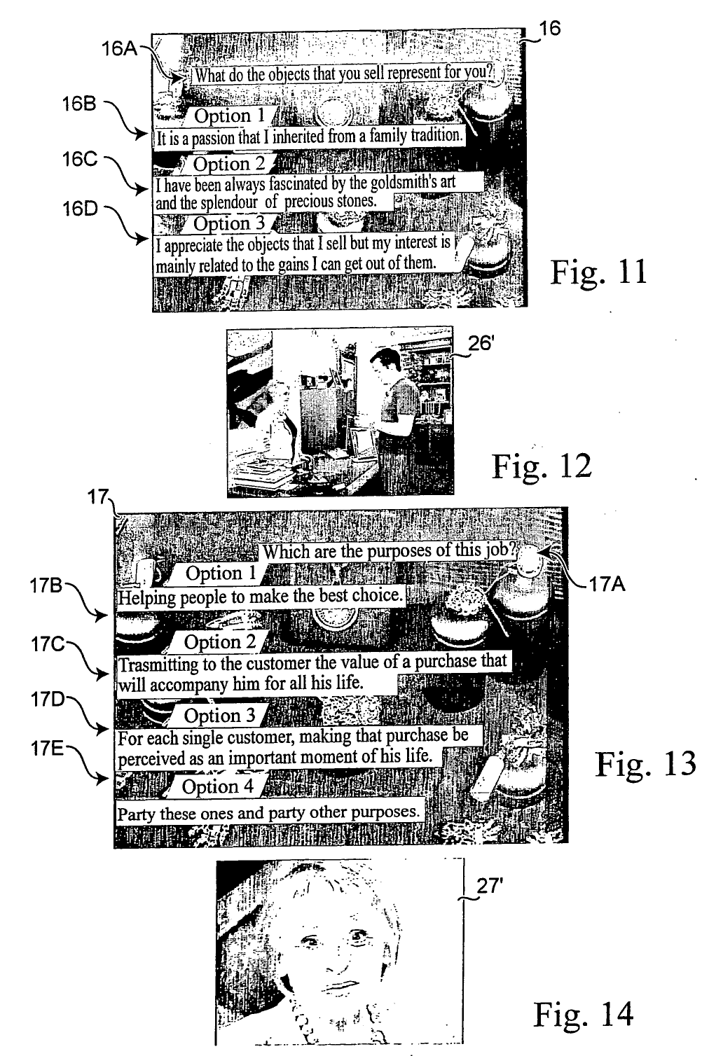

At the end of playing the sub-movie 25, the display 2 shows a sixth interface 16 requiring a suitable selection through the remote control 5 of one from three different options. By way of example, such interface 16 is shown in FIG. 11, where it may be observed a question 16A and three selectable texts 16B, 16C, and 16D, corresponding to the three possible responses to the question 16A which the user may select through the remote control 5.

As shown in FIG. 2, assuming that the user has selected through the remote control 5 the third response of the interface 16 (i.e. the third selectable text 16D of FIG. 11), the DVD player 3 plays on the display 2 a sub-movie 26 corresponding to such response, of which the FIG. 12 shows an image 26′. Similarly to what already seen, at the end of playing the sub-movie 26, the display 2 shows a seventh interface 17 requiring a suitable selection through the remote control 5 of one from four different options. Such interface 17 is shown in FIG. 13, where it may be observed a question 17A and four selectable texts 17B, 17C, 17D, and 17E corresponding to the four possible responses to the question 17A which the user may select through the remote control 5.

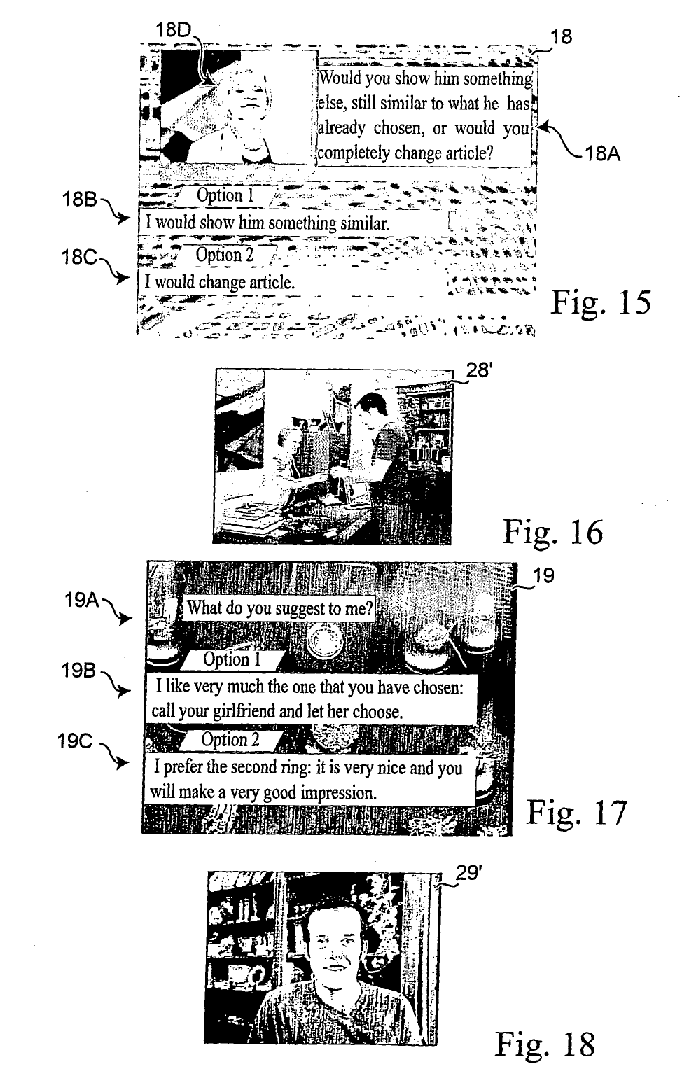

As shown again in FIG. 2, assuming that the user has selected through the remote control 5 the third response of the interface 17 (i.e. the third selectable text 17D of FIG. 13), the DVD player 3 plays on the display 2 a sub-movie 27 corresponding to such response, of which FIG. 14 shows an image 27′. As above, at the end of playing the sub-movie 27, the display 2 shows an eighth interface 18 requiring a suitable selection through the remote control 5 of one from two different options. The eighth interface 18 is shown in FIG. 15, where it may be observed a question 18A, two selectable texts 18B and 18C corresponding to the two possible responses to the question 18A which the user may select through the remote control 5, and a panel 18D wherein an image and/or a video sequence is shown.

Always with reference to FIG. 2, assuming that the user has selected through the remote control 5 the second response of the interface 18 (i.e. the second selectable text 18C of FIG. 15), the DVD player 3 plays on the display 2 a sub-movie 28 corresponding to such response, of which FIG. 16 shows an image 28′. Again, at the end of playing the sub-movie 28, the display 2 shown a ninth interface 19 requiring a suitable selection through the remote control 5 of one from two different options. The ninth interface 19 is shown in FIG. 17, where it may be observed a question 19A, and two selectable texts 19B and 19C corresponding to the two possible responses to the question 19A which the user may select through the remote control 5.

As shown in FIG. 2, assuming that the user has selected through the remote control 5 the first response of the interface 19 (i.e. the first selectable text 19B of FIG. 17), the DVD player 3 plays on the display 2 a sub-movie 29 corresponding to such response, of which FIG. 18 shows an image 29′, that ends interactive movie playing.

With reference to FIG. 19, it may be observed a second embodiment of the system employing the memory medium according to the invention. In such system, it may be observed that N remote controls 5A, 5B, . . . , 5N may make the selections proposed through the interfaces displayed on the display 2. Such selections may be independent of each other and are received (and recognised as independent) by a suitable device 6 that, upon reception of a minimum number M of selections, with M≦N, from the N remote controls, i.e. upon reception of a minimum number P, with P≦N, of selections in agreement with each other from the N remote controls, emits a selection signal 7 towards the DVD player 3. For instance, the signal 7 may be an Infrared or IR signal as the signal of the remote control 5 of the player 3. In particular, two discordant selections coming from the same remote control of the plurality may be handled in various ways: for instance, the second one may be neglected, or it may replace the first one.

Alternatively, the device 6 for receiving and recognising the selections from the plurality of N remote controls (configurable preferably plurality) may be integrated into the DVD player 3.

Moreover, both the embodiments of the system employing the memory medium according to the invention shown in FIGS. 1 and 19, may provide that the DVD player 3 has a processing unit 8 (indicated in dashed lines in Figures), apt to calculate scores depending on the selections made by the users (possibly, in the case of the embodiment of FIG. 19, customised scores for each remote control of the plurality), to be shown in suitable fields of special interfaces, stored on the DVD disc 1, which may be advantageously shown at the end of the interactive movie playing for displaying scores obtained with the selections made during playing, for instance, a training interactive movie. In this regard, such scores may concern: the evaluation of correctness of the selections made and reaction times (i.e. selection speed), which in the case of the system of FIG. 19 may refer to both the group of users and single users. Also, in the case of the system of FIG. 19, scores may further concern: majority and minority aggregations in the made selections, coherence characteristics in the selections of single users (indicative of constancy with which a single user has been possibly part of either the majority or the minority in the selections made), leadership characteristics (indicative, for instance, of the selection promptness by a single user with respect to the others), other statistical data.

The present invention has been described, by way of illustration and not by way of limitation, according its preferred embodiment, but it should be understood that those skilled in the art can make variations and/or changes, without so departing from the related scope of protection, as defined by the enclosed claims.

1. A memory medium storing a set of sub-movies and one or more graphic interfaces, readable by a DVD (“Digital Versatile Disk”) player connected to a display on which it is apt to play at least one sequence of two or more sub-movies conditional on one or more selections made by at least one user through at least one control device apt to interact with the DVD player, characterised in that said at least one control device interacts with the DVD player at least at the end of playing a first sub-movie for selecting a second sub-movie from a sub-set of sub-movies corresponding to the first sub-movie, at the end of playing the first sub-movie being displayed on the display at least one interface, corresponding to the first sub-movie, of said one or more graphic interfaces.

2. A medium according to claim 1, characterised in that at least one sub-movie of said set comprises two or more video and/or audio component sequences.

3. A medium according to claim 2, characterised in that at least two sub-movies of said set comprise at least one same video and/or audio component sequence.

4. A medium according to claim 2, characterised in that said medium stores, for each sub-movie comprising two or more video sequences and/or audio components, references or pointers to the memory locations of the medium storing the corresponding video and/or audio component sequences.

5. A medium according to claim 1 characterised in that said at least one interface corresponding to the first sub-movie comprises at least two selectable fields.

6. A medium according to claim 5, characterised in that at least one of said at least two selectable fields is a text field.

7. A medium according to claim 1, characterised in that said at least one interface corresponding to the first sub-movie shows at least one question.

8. A medium according to claim 1, characterised in that said at least one interface corresponding to the first sub-movie comprises at least one panel showing an image and/or a video and/or audio sequence.

9. A medium according to claim 1, characterised in that said at least one interface corresponding to the first sub-movie comprises at least one video and/or audio sequence that is played during display of the corresponding interface.

10. A medium according claim 1, characterised in that it is a DVD (“Digital Versatile Disk”) disc.

11. A medium according to claim 1, characterised in that it is a CDROM disc.

12. A medium according to claim 1, characterised in that it is a USB card.

13. An electronic file comprising at least one data structure storing a set of sub-movies and one or more graphic interfaces, apt to be stored on the memory medium according to claim 1.

14. An electric, magnetic, or electromagnetic signal modulated by an information signal, characterised in that said information signal comprises the electronic file according to claim 13.

15. A video playing system, comprising a DVD player, provided with at least one display, apt to read at least one memory medium according to claim 1, the system comprising at least two control devices apt to interact with the DVD player, the system being characterised in that it comprises a device for receiving peripheral selection signals coming from said at least two control devices, the receiving device transmitting a central selection signal towards the DVD player upon reception of a minimum number (N, P) of peripheral selection signals, the central selection signal corresponding to the majority peripheral selection signal among those received by the device.

16. A system according to claim 15, characterised in that said receiving device is apt to recognise the control devices from which said peripheral selection signals come.

17. A system according to claim 15, characterised in that the receiving device transmits a central selection signal towards the DVD player upon reception of a minimum number (P) of peripheral selection signals corresponding to the same selection.

18. A system according to claim 15, characterised in that the receiving device is integrated into the DVD player.

19. A system according to claim 15, characterised in that it comprises processing means apt to calculate at least one score depending on the interactions of said at least two control devices with the DVD player.

20. A video playing system, comprising a DVD player, provided with at least one display, apt to read at least one memory medium according to claim 1, the system comprising at least one control device apt to interact with the DVD player, the system being characterised in that it comprises processing means apt to calculate at least one score depending on the interactions of said at least one control devices with the DVD player.
